(19) United States
(12) Patent Application Publication
(10) Pub. No.: US 2024/0260578 A1
(43) Pub. Date: Aug. 8, 2024

(54) HERBICIDAL COMPOSITIONS AND RELATED METHODS

(71) Applicant: BELCHIM Crop Protection USA LLC, Wilmington, DE (US)

(72) Inventors: Jerry L. CORBETT, Selma, NC (US); Bret CORBETT, Raleigh, NC (US)

(21) Appl. No.: 18/430,931

(22) Filed: Feb. 2, 2024

Related U.S. Application Data
(60) Provisional application No. 63/443,094, filed on Feb. 3, 2023.

(51) Int. Cl. A01N 47/06; A01N 43/653; A01P 13/00

(52) U.S. Cl. CPC A01N 47/06; A01N 43/653; A01P 13/00

(57) ABSTRACT

Herbicidal compositions are provided that include a herbicidally synergistic amount of at least one at least one photosynthesis II inhibitor and a herbicidally synergistic amount of at least one protoporphyrinogen oxidase (PPO). The herbicidal composition is synergistically effective against annual and perennial broadleaf weeds, grassy weeds, and sedges. Methods of burndown treatment and control of undesirable vegetation are also provided.

### CROSS-REFERENCE TO RELATED APPLICATIONS

The present application claims priority to U.S. Provisional Application No. 63/443,094 filed Feb. 3, 2023, the contents of which is incorporated herein in its entirety.

### BACKGROUND OF THE DISCLOSURE

Undesirable vegetation such as annual and perennial broadleaf weeds, grassy weeds, and sedges continue to be a problem for turf grasses and crops. In particular, sedges are increasing in acreage in the United States every year and becoming more problematic with regards to selectively controlling in lawns, landscapes as well as other non-crop areas. Yellow nutsedge and Purple nutsedge are the most common sedges found in non-crop areas, however, green Kyllinga and false-green Kyllinga have become more problematic in recent years.

### SUMMARY OF THE DISCLOSURE

Provided herein are herbicidal compositions containing, among the other components, a combination of herbicidal compounds in effective amounts that result in improved burndown or elimination of unwanted vegetation. The herbicidal compositions provided herein utilize a combination of the herbicidal compounds that show enhanced herbicide action compared to any individual herbicidal compound, alone, when applied to undesirable vegetation.

An herbicidal composition is provided. The herbicidal composition includes at least one photosynthesis II inhibitor; and at least one protoporphyrinogen oxidase (PPO). According to one embodiment, the at least one photosynthesis II inhibitor is a symmetrical triazine, triazinone, triazole, triazolone, triazolinone, substituted urea, uracil, pyridazinone, phenyl carbamate, nitrile, benzothiadiazole, phenyl pyridazine, phenyl-carbamate, or acid amide. According to one embodiment, the at least one photosynthesis II inhibitor is pyridate, amicarbazone, bromacila, chloridazone/pyrazone, demedipham, lenacil, pentanochlor, fenmedipham, propanyl, pyridafol, terbacyl, tidiazurone, or agriculturally acceptable salts thereof. According to one embodiment, the at least one photosynthesis II inhibitor is pyridate. According to one embodiment, the at least one protoporphyrinogen oxidase (PPO) is sulfentrazone, piralflufen-ethyl, carfentrazone-ethyl, flumioxazin, butafenacil, saflufenacil, oxadiargyl, pentoxazone, flutiacet-methyl, piraclonyl o-flurfenpyr-ethyl or agriculturally acceptable salts thereof. According to one embodiment, the at least one protoporphyrinogen oxidase (PPO) is sulfentrazone. According to one embodiment, the herbicidal composition is formulated as a ready-to-use (RTU) formulation, emulsifiable concentrate (EC), microemulsifiable concentrate, oil dispersion (OD), powder, water dispersible granule (WG), or water soluble granule (SG).

A method for burndown treatment of undesirable vegetation is provided and includes applying the herbicidal composition as provided herein onto or around:
a locus where desirable will be planted or emerge; or
a locus where undesirable vegetation is present or is expected to be present.

According to one embodiment, the undesirable vegetation is a sedge.

A method of controlling growth of undesirable vegetation is provided and includes applying the herbicidal composition as provided herein onto or around:
a locus where desirable vegetation will be planted or emerge; or
a locus where undesirable vegetation is present or is expected to be present. According to one embodiment, the undesirable vegetation is a sedge.

A kit is provided. The kit includes at least one herbicidal composition as provided herein; and, optionally, instructions for use.

A tank mix herbicidal composition is provided. The tank mix herbicidal composition includes at least one herbicidal composition as provided herein; and water, spray oil, or a combination of water and spray oil.

A herbicidal composition is provided. The herbicidal composition includes from about 0.01 percent weight to about 0.5 percent weight of at least one photosynthesis II inhibitor; and from about 0.01 weight percent to about 0.5 weight percent of at least one at least one protoporphyrinogen oxidase (PPO). According to one embodiment, the at least one photosynthesis II inhibitor is pyridate. According to one embodiment, the at least one protoporphyrinogen oxidase (PPO) is sulfentrazone. According to one embodiment, the at least one photosynthesis II inhibitor is pyridate and the at least one protoporphyrinogen oxidase (PPO) is sulfentrazone. According to one embodiment, the aforementioned herbicidal composition is formulated as a ready-to-use (RTU) formulation, emulsifiable concentrate (EC), microemulsifiable concentrate, oil dispersion (OD), powder, water dispersible granule (WG), or water soluble granule (SG). According to one embodiment, the aforementioned herbicidal composition is formulated as a ready-to-use (RTU) formulation that includes from about 0.0175% v/v to about 0.5% v/v of at least one photosynthesis II inhibitor per gallon of RTU formulation; and from about 0.0162% v/v to about 0.6% v/v of at least one protoporphyrinogen oxidase (PPO) inhibitor per gallon of RTU formulation.

### DETAILED DESCRIPTION OF THE DISCLOSURE

The present disclosure will now be described more fully hereinafter with reference to exemplary embodiments thereof. These exemplary embodiments are described so that this disclosure will be thorough and complete, and will fully convey the scope of the disclosure to those skilled in the art. Indeed, the present disclosure may be embodied in many different forms and should not be construed as limited to the embodiments set forth herein; rather, these embodiments are provided so that this disclosure will satisfy applicable legal requirements. As used in the specification, and in the appended claims, the singular forms “a”, “an”, “the”, include plural referents unless the context clearly dictates otherwise.

As used herein, the terms “controlling” and “combating” are synonyms.

As used herein, the terms “undesirable vegetation” and “weeds” are synonyms. These terms refer to a plant growing (or about to grow or emerge) in competition with a desirable cultivated plant or crop. Examples of undesirable vegetation include, but are not limited to, annual and perennial broadleaf weeds, grassy weeds, and sedges. Specific non-limiting examples of undesirable vegetation include Beggarweed, Carpetweed, Chickweed, Cocklebur, Copperleaf, Crabgrass, Croton, Daisy, Dayflower, Deadnettle, Dock, Eclipta, Fixweed, Galinsoga, Groundcherry, Hemp, Henbit, Jimsonweed, Kochia, Lambsquarter, Lettuce, Mallow, Mayweed, Milkweed, Mexican weed Morning glory, Mustard, Nightshade, Palmer amaranth, Pigweed, Purslane, Sedge (all members of the Cyperaceae family including yellow, purple, green annual, cylindric, globe, surinam, Kyllinga (green, false-green)), Senna, Sheperds purse, Sunflower, Thistle, Waterhemp, or Yellow rocket.

As used herein, the term “herbicide” or “herbicidal” refers to one or more chemical compounds that control or otherwise eliminate (e.g., burndown) undesirable vegetation (post emergent) or act as a pre-emergent to prevent growth of undesirable vegetation.

As used herein, the term “synergistic” or “synergistic effect” refers to increased efficacy of herbicidal action of a herbicidal composition compared to the herbicidal action of herbicidal compounds contained therein when administered individually. That is, the herbicidal action of the herbicidal composition exceeds the action of the active compounds when administered alone. The expected activity of a given combination of herbicidal compound can be, but not necessarily, calculated as follows according to a calculation method by Colby (See COLBY, S. R.: “Calculating synergistic and antagonistic responses of herbicide combinations”, Weeds 15, pages 20-22, 1967): If X=% damage by herbicide (A) at an application rate of m g/ha, Y=% damage by herbicide (B) at an application rate of n g/ha, E=the expected damage by herbicides (A) and (B) at application rates of m and n kg/ha and, then for a combination: E=X+Y−(Xx Y)/100.

### Herbicidal Compositions

Provided herein are herbicidal compositions containing, among the other components, a combination of herbicidal compounds in effective amounts that result in improved burndown or elimination of unwanted vegetation. The herbicidal compositions provided herein utilize a combination of the herbicidal compounds that show enhanced herbicide action compared to any individual herbicidal compound, alone, when applied to undesirable vegetation. The herbicidal compositions provided herein also result in minimal, if any, damage to any surrounding crop or turf grass. The herbicidal compositions as provided herein may be applied before emergence or after the emergence of the target undesirable vegetation. The herbicidal compounds provided herein exhibit accelerated action or a synergistic effect on undesirable vegetation and may effect damage more quickly in comparison with solo applications of the individual herbicidal compounds. The synergistic effects permits a reduction of the application rates of the individual herbicidal compounds, a higher and longer efficacy at the same application rate, the control of undesirable vegetation species which are tolerant or resistant to individual herbicides or to a number of other herbicides, an extension of the period of application and reduction in the number of individual applications required and, as a result for the user, economically and ecologically advantageous control of undesirable vegetation.

### Photosynthesis II Inhibitor

According to one embodiment, the herbicidal compositions provided herein include at least one herbicide that is a photosynthesis II inhibitor. Thus, the herbicidal compositions include at least one herbicide that inhibits a weed's photosystem II process, triggering the release of toxic forms of oxygen and causing rapid cell wall degradation resulting in undesirable vegetation death.

According to one embodiment, the photosynthesis II inhibitor may be one or more of a symmetrical triazine, triazinone (asymmetrical triazines), triazole, triazolone, triazolinone, substituted urea, uracil, pyridazinone, phenyl carbamate, nitrile, benzothiadiazole, phenyl pyridazine, phenyl-carbamate, or acid amide. According to one embodiment, the photosynthesis II inhibitor includes one or more of pyridate, amicarbazone, bromacila, chloridazone/pyrazone, demedipham, lenacil, pentanochlor, fenmedipham, propanyl, pyridafol, terbacyl, tidiazurone, and agriculturally acceptable salts thereof.

### PPO Inhibitor

According to one embodiment, the herbicidal compositions provided herein include at least one herbicide that is a protoporphyrinogen oxidase (PPO) inhibitor. The PPO inhibitor may act by inhibiting an enzyme involved in chlorophyll biosynthesis leading to an accumulation of intermediates that are highly reactive when exposed to light resulting in membrane disruption and undesirable vegetation death.

According to one embodiment, the PPO inhibitor is one or more of sulfentrazone, piralflufen-ethyl, carfentrazone-ethyl, flumioxazin, butafenacil, saflufenacil, oxadiargyl, pentoxazone, flutiacet-methyl, piraclonyl o-flurfenpyr-ethyl, and agriculturally acceptable salts thereof.

### Additional Components

According to one embodiment, the herbicidal compositions as provided herein may include one or more additional components such as herbicides, insecticides, fungicides or other active pesticide ingredients, safeners, antioxidants, chemical stabilizers, adhesives, fertilizers, perfumes, humectants, such as, for example, propylene glycol, and dyestuffs. According to one embodiment, the herbicide composition can also include various agrochemically active compounds, for example from the group of the acaricides, nematicides, bird repellants, and soil structure improvers.

According to one embodiment, the herbicidal compositions provided herein further includes at least one surfactant (or dispersant). According to one embodiment, the surfactant allows the herbicidal composition to spread more easily, absorb faster and is not readily washed out by rain. According to one embodiment, the surfactant is a polyethoxylate, nonylphenol, octylphenol, organosilicone. According to another embodiment, the surfactant is an anionic surfactant such as sodium lauryl sulfate, sodium laureth sulfate, ammonium lauryl sulfate, ammonium laureth sulfate, sodium stearate, or potassium cocoate. According to another embodiment, the surfactant is a nonionic surfactant such as cocamide monoethanolamine, cocamide diethanolamine, fatty alcohol ethoxylates, amine oxides, or sulfoxides.

According to one embodiment, the herbicidal compositions provided herein further includes at least one emulsifier or foam former. Suitable emulsifiers include, but are not limited to, nonionic and anionic emulsifiers, such as polyoxyethylene fatty acid esters, polyoxyethylene fatty alcohol ethers, alkylaryl polyglycol ethers, alkylsulfonates, alkylsulfates, arylsulfonates and protein hydrolyzates.

According to one embodiment, the herbicidal compositions provided herein include an extender. According to one embodiment, the extender is water, xylene, toluene, an alkylnaphthalene, chlorobenzenes, chloroethylenes, methylene chloride, cyclohexane, mineral oil fractions, mineral and vegetable oils, alcohols, ethers, esters, ketones such as acetone, methyl ethyl ketone, methyl isobutyl ketone, cyclohexanone, dimethylformamide, dimethyl sulfoxide, or a combination thereof.

According to one embodiment, the herbicidal compositions provided herein further include at least one solid carrier. Suitable solid carriers include, but are not limited to, kaolins, clays, talc, chalk, quartz, attapulgite, montmorillonite or diatomaceous earth, and ground synthetic minerals, such as finely divided silica, alumina and silicates.

According to one embodiment, the herbicidal compositions provided herein further include at least flow agent. Suitable flow agents include, but are not limited to, clays such as kaolin, talc, diatomaceous earth and propylene glycol.

### Formulations

The herbicidal compositions as provided herein may also be formulated as a ready-to-use (RTU) formulation, emulsifiable concentrate (EC) formulation, microemulsifiable concentrate, oil dispersion (OD) formulation, powder (e.g., wettable powder (WP)), water dispersible granule (WG), or water soluble granule (SG) formulation. A wettable powder may be dissolved in an appropriate solvent such as water. In other embodiments, the herbicidal compositions as provided herein may be formulated as a tank mix and applied as a water-based spray mixture that may contain various other products including additional herbicides, fertilizers, surfactants, adjuvants, and other components as provided herein. According to a particular embodiment, a tank mix herbicidal composition is provided that includes from typically about 80.0% v/v to about 99.9% v/v of at least one solvent with the remaining tank mix comprising an herbicidal composition as provided herein. According to a particular embodiment, the solvent includes water, spray oil (e.g., phytobland or paraffinic oil), or a combination thereof.

According to another embodiment, the herbicidal compositions as provided herein may be formulated as a separate, stand-alone product (powder or liquid) that is added to a tank mix at the time of use.

The herbicidal compositions provided herein may contain a herbicidally effective synergistic amount of at least one photosynthesis II inhibitor and at least one protoporphyrinogen oxidase (PPO) inhibitor. In some embodiments, the concentrations of the at least one photosynthesis II inhibitor and at least one protoporphyrinogen oxidase (PPO) inhibitor in the formulations can be varied.

In some embodiments, the herbicidal compositions final formulations contain from about 0.01 weight percent to about 0.5 weight percent in total weight of each of the at least one photosynthesis II inhibitor and at least one protoporphyrinogen oxidase (PPO) inhibitor. In some embodiments, the herbicidal compositions final formulations contain from about 0.025 weight percent to about 0.25 weight percent in total weight of each of the at least one photosynthesis II inhibitor and at least one protoporphyrinogen oxidase (PPO) inhibitor. In some embodiments, the herbicidal compositions final formulations contain from about 0.05 weight percent to about 0.1 weight percent in total weight of each of the at least one photosynthesis II inhibitor and at least one protoporphyrinogen oxidase (PPO) inhibitor.

In some embodiments, the herbicidal compositions final formulations including at least one photosynthesis II inhibitor and at least one protoporphyrinogen oxidase (PPO) inhibitor may be applied at a rate of from about 50 grams active ingredient per hectare (gai/ha) to about 600 gai/ha. In some embodiments, the herbicidal compositions final formulations including at least one photosynthesis II inhibitor and at least one protoporphyrinogen oxidase (PPO) inhibitor may be applied at a rate of from about 100 grams active ingredient per hectare (gai/ha) to about 500 gai/ha. In some embodiments, the herbicidal compositions final formulations including at least one photosynthesis II inhibitor and at least one protoporphyrinogen oxidase (PPO) inhibitor may be applied at a rate of from about 195 grams active ingredient per hectare (gai/ha) to about 390 gai/ha.

The herbicidal compositions as provided herein may be formulated as a concentrate. The concentrates can be diluted with an inert carrier, such as water, or oil, or a combination thereof before application. In formulations designed to be used as concentrates, each of the at least one photosynthesis II inhibitor and at least one protoporphyrinogen oxidase (PPO) inhibitor may be present in a concentration of about 0.01 weight percent to about 0.32 weight percent, based on the total weight of the formulation. In formulations designed to be used as concentrates, each of the at least one photosynthesis II inhibitor and at least one protoporphyrinogen oxidase (PPO) inhibitor may be present in a concentration of about 0.02 weight percent to about 0.16 weight percent, based on the total weight of the formulation. In formulations designed to be used as concentrates, each of the at least one photosynthesis II inhibitor and at least one protoporphyrinogen oxidase (PPO) inhibitor may be present in a concentration of about 0.04 weight percent to about 0.08 weight percent, based on the total weight of the formulation.

In formulations designed to be used as concentrates, each of the at least one photosynthesis II inhibitor and at least one protoporphyrinogen oxidase (PPO) inhibitor may be applied at a rate of from about 50 gai/ha to about 500 gai/ha. In formulations designed to be used as concentrates, each of the at least one photosynthesis II inhibitor and at least one protoporphyrinogen oxidase (PPO) inhibitor may be applied at a rate of from about 100 gai/ha to about 400 gai/ha. In formulations designed to be used as concentrates, each of the at least one photosynthesis II inhibitor and at least one protoporphyrinogen oxidase (PPO) inhibitor may be applied at a rate of from about 145 gai/ha to about 290 gai/ha.

According to another embodiment, the herbicidal compositions as provided herein may be in a diluted formulation that is applied to undesirable vegetation or the locus of undesirable vegetation. According to one embodiment, diluted formulations may contain from about 0.025 weight percent to about 0.25 weight percent of each of the at least one photosynthesis II inhibitor and at least one protoporphyrinogen oxidase (PPO) inhibitor, based on the total weight of the diluted formulation. According to one embodiment, diluted formulations may contain from about 0.05 weight percent to about 0.15 weight percent of each of the at least one photosynthesis II inhibitor and at least one protoporphyrinogen oxidase (PPO) inhibitor, based on the total weight of the diluted formulation. According to one embodiment, diluted formulations may contain from about 0.1 weight percent to about 0.08 weight percent of each of the at least one photosynthesis II inhibitor and at least one protoporphyrinogen oxidase (PPO) inhibitor, based on the total weight of the diluted formulation.

According to one embodiment, diluted formulations provided herein may be applied at a rate of from about 50 gai/ha to about 600 gai/ha. According to one embodiment, diluted formulations provided herein may be applied at a rate of from about 150 gai/ha to about 500 gai/ha. According to one embodiment, diluted formulations provided herein may be applied at a rate of from about 290 gai/ha to about 390 gai/ha.

The herbicidal compositions as provided herein may be formulated as a ready-to-use (RTU) formulation. According to one embodiment, the RTU formulations include from about 0.0175% v/v to about 0.5% v/v of at least one photosynthesis II inhibitor per gallon of formulation and from about 0.0162% v/v to about 0.6% v/v of at least one protoporphyrinogen oxidase (PPO) inhibitor per gallon of formulation. According to one embodiment, the RTU formulations include from about 0.1% v/v to about 0.3% v/v of at least one photosynthesis II inhibitor per gallon of formulation and from about 0.1% v/v to about 0.3% v/v of at least one protoporphyrinogen oxidase (PPO) inhibitor per gallon of formulation. According to one embodiment, the RTU formulations include about 0.175% v/v of at least one photosynthesis II inhibitor per gallon of formulation and about 0.162% of at least one protoporphyrinogen oxidase (PPO) inhibitor per gallon of formulation.

### Herbicidal Composition Preparation and Application

According to one embodiment, the herbicidal compositions as provided herein may be applied post-emergence directly to the foliage (e.g., leaves or stems) or roots of undesirable vegetation. If an herbicide composition as provided herein is applied post-emergence to the undesirable vegetation, growth may cease directly after the treatment and begin to die. In this manner, infestation of undesirable vegetation may be eliminated very early and in a sustained manner.

According to one embodiment, the herbicidal compositions as provided herein may be applied directly to soil surrounding the foliage (e.g., leaves) of a plant to control undesirable vegetation growth. According to one embodiment, the herbicidal compositions as provided herein may be introduced or otherwise applied to a plant previously treated with (e.g., sprayed with) a pesticide. The herbicidal composition as provided herein may also contain other pesticides and other chemicals known to be useful for controlling plant diseases or pests or promoting plant health.

According to one embodiment, the herbicidal compositions as provided herein may be introduced or applied in a liquid form (e.g., spray mixture) or by mixing the dried form with water to form an aqueous solution and spraying the resulting solution using conventional agricultural sprayers and spraying techniques well known in the art. The herbicidal compositions in a liquid form may be diluted with water and applied to undesirable vegetation by spraying (either aerial or ground) or by chemigation. According to one embodiment, the individual herbicidal compounds described herein are sequentially applied, for example by the post-emergence method or early post-emergence applications followed by medium or late post-emergence applications. According to one embodiment, the herbicidal compositions as provided herein are freshly prepared prior to use. According to such an embodiment, the herbicidal compositions are prepared within one to 24 hours prior to use. According to one embodiment, application of the herbicidal compositions provided herein is accomplished in a customary manner, for example by watering, spraying, atomizing, sprinkling, showering, spritzing, spreading in droplets, spattering, dispersing, diffusing or broadcasting.

According to one embodiment, the herbicidal compositions as provided herein may be prepared by known processes, for example, as mixed formulations or emulsifiable concentrate (EC) formulations of the individual components, if appropriate with further active compounds, additives and/or customary formulation auxiliaries, which combinations are then applied in a customary manner diluted with water, or as tank mixes by dilution of components, formulated separately or formulated partially separately, with water. According to one embodiment, the herbicidal compositions as provided herein may be produced by mixing together the herbicidal compounds as provided herein with a solvent or extender followed by agitation and introduction of other components provided herein such as emulsifiers and surfactants.

According to one embodiment, the herbicidal compositions as provided herein may include a herbicidally effective synergistic amount of at least one photosynthesis II inhibitor such that the at least one photosynthesis II inhibitor is applied at a rate of from about 1 fluid ounce per acre to about 50 fluid ounces per acre. According to one embodiment, the herbicidal compositions provided herein include a herbicidally effective synergistic amount of at least one photosynthesis II inhibitor such that the at least one photosynthesis II inhibitor is applied at a rate of from about 10 fluid ounces per acre to about 40 fluid ounces per acre. According to one embodiment, the herbicidal compositions provided herein include a herbicidally effective synergistic amount of at least one photosynthesis II inhibitor such that the at least one photosynthesis II inhibitor is applied at a rate of from about 20 fluid ounces per acre to about 30 fluid ounces per acre. According to one embodiment, the herbicidal compositions provided herein include a herbicidally effective synergistic amount of at least one photosynthesis II inhibitor such that the at least one photosynthesis II inhibitor is applied at a rate of about 25 fluid ounces per acre.

According to one embodiment, the herbicidal compositions as provided herein may include a herbicidally effective synergistic amount of at least one protoporphyrinogen oxidase (PPO) inhibitor such that the at least one protoporphyrinogen oxidase (PPO) inhibitor is applied at a rate of from about 1 fluid ounce per acre to about 30 fluid ounces per acre. According to one embodiment, the herbicidal compositions provided herein include a herbicidally effective synergistic amount of at least one protoporphyrinogen oxidase (PPO) inhibitor such that the at least one protoporphyrinogen oxidase (PPO) inhibitor is applied at a rate of from about 5 fluid ounces per acre to about 25 fluid ounces per acre. According to one embodiment, the herbicidal compositions provided herein include a herbicidally effective synergistic amount of at least one protoporphyrinogen oxidase (PPO) inhibitor such that the at least one protoporphyrinogen oxidase (PPO) inhibitor is applied at a rate of from about 10 fluid ounces per acre to about 20 fluid ounces per acre. According to one embodiment, the herbicidal compositions provided herein include a herbicidally effective synergistic amount of at least one protoporphyrinogen oxidase (PPO) inhibitor such that the at least one protoporphyrinogen oxidase (PPO) inhibitor is applied at a rate of from about 11 fluid ounces per acre to about 13 fluid ounces per acre. According to one embodiment, the herbicidal compositions provided herein include a herbicidally effective synergistic amount of at least one protoporphyrinogen oxidase (PPO) inhibitor such that the at least one protoporphyrinogen oxidase (PPO) inhibitor is applied at a rate of about 12 fluid ounces per acre.

According to one embodiment, the herbicidal compositions as provided herein exhibit increased efficacy compared to each of the herbicidal compounds contained therein when applied individually at the recommend herbicidally effective application rate. According to one embodiment, the herbicidal compositions as provided herein exhibit increased efficacy of at least 5% compared to each of the herbicidal compounds contained therein when applied individually at the recommend herbicidally effective application rate. According to one embodiment, the herbicidal compositions as provided herein exhibit increased efficacy of at least 10% compared to each of the herbicidal compounds contained therein when applied individually at the recommend herbicidally effective application rate. According to one embodiment, the herbicidal compositions as provided herein exhibit increased efficacy of at least 15% compared to each of the herbicidal compounds contained therein when applied individually at the recommend herbicidally effective application rate. According to one embodiment, the herbicidal compositions as provided herein exhibit increased efficacy of at least 20% compared to each of the herbicidal compounds contained therein when applied individually at the recommend herbicidally effective application rate. According to one embodiment, the herbicidal compositions as provided herein exhibit increased efficacy of at least 25% compared to each of the herbicidal compounds contained therein when applied individually at the recommend herbicidally effective application rate. According to one embodiment, the herbicidal compositions as provided herein exhibit increased efficacy of at least 30% compared to each of the herbicidal compounds contained therein when applied individually at the recommend herbicidally effective application rate. According to one embodiment, the herbicidal compositions as provided herein exhibit increased efficacy of at least 35% compared to each of the herbicidal compounds contained therein when applied individually at the recommend herbicidally effective application rate. According to one embodiment, the herbicidal compositions as provided herein exhibit increased efficacy of at least 40% compared to each of the herbicidal compounds contained therein when applied individually at the recommend herbicidally effective application rate. According to one embodiment, the herbicidal compositions as provided herein exhibit increased efficacy of at least 45% compared to each of the herbicidal compounds contained therein when applied individually at the recommend herbicidally effective application rate. According to one embodiment, the herbicidal compositions as provided herein exhibit increased efficacy of at least 50% compared to each of the herbicidal compounds contained therein when applied individually at the recommend herbicidally effective application rate. According to one embodiment, the aforementioned efficacy rates are achieved at 1, 2, 4, 8, 10, 13, 20, 25, 30, 35, 40, 45, 50, 55, 60, 65, 70, 75, 80, 85, 90, 95, or 100 days or more after treatment.

The herbicidal compositions as provided herein are also useful in controlling undesirable vegetation in any environment such as on or around trees, bushes, or turf grasses. The herbicidal compositions may be particularly useful in controlling undesirable vegetation associated with turf grass. Such turf grass may be found in residential or institutional laws, athletic fields, golf courses, sod farms, or any non-crop site.

According to one embodiment, the herbicidal compositions provided herein are appropriate for use on cool season grasses. Cool season grasses include bentgrass, fescue (tall, fine, etc.) ryegrass, perennial, and bluegrass (Kentucky, Rough, etc.).

According to one embodiment, the herbicidal compositions provided herein are appropriate for use on warm season grasses. Warm season grasses include bahiagrass, bluffalograss, carpetgrass, centipedegrass, kikuyugrass, zoysiagrass, bermudagrass and St. Augustine.

The herbicidal compositions as provided herein are useful in controlling undesirable vegetation in and around crops. Suitable crops include, but are not limited to, plants including citrus, such as grapefruit, lemon, lime, orange, tangelo and tangerine; field crops, such as alfalfa, oats, peanuts, potatoes, sugar beets, soybeans, corn, canola, wheat, and barley; small fruits, such as blackberry, cranberry, currant, gooseberry, raspberry and strawberry; tree crops, such as almond, apple, apricot, avocado, banana, cacao, cherry, coffee, filberts, mango, nectarine, olive, peach, pear, pecan, plum, prune and walnut; vegetables, such as beans, broccoli, brussel sprout, cabbage, cantaloupe, carrot, cauliflower, celery, collards, cucumber, eggplant, honeydew, muskmelon, onions, peas, peppers, pumpkin, squash, tomato and watermelon; vines, such as grape, hops and kiwi.

According to one embodiment, a kit is provided. The kit may include one or more spatially separated herbicidal compounds and other components according to the herbicidal compositions provided herein. According to an alternative embodiment, the kit includes at least one herbicidal composition as provided herein that is ready to use and be applied directly to undesirable vegetation. According to an alternative embodiment, the kit includes at least one herbicidal composition as provided herein that is ready to be diluted with a solvent as described herein prior to use. The kits as provided herein may also include a set of instructions for use.

Although specific embodiments of the present invention are herein illustrated and described in detail, the invention is not limited thereto. The above detailed descriptions are provided as exemplary of the present invention and should not be construed as constituting any limitation of the invention. Modifications will be obvious to those skilled in the art, and all modifications that do not depart from the spirit of the invention are intended to be included with the scope of the appended claims.

### Example 1

Field trials were conducted to evaluate the efficacy of pyridate herbicide alone and in combination with sulfentrazone when applied in a post-emergent manner to established Yellow nutsedge (Cypersus esculentus). The field trial was conducted alongside of a gravel path on the Corbett Farm located Batten Pond Road in Selma, NC 27576. Yellow nutsedge was established and ranged from 8-12 inches in height. The distribution of weeds in the plots was uniform throughout this location.

Individual treatments were applied on a 1×4 meter squared plot area. The experimental design was a non-replicated linear strip plot. The applications were made with a RYOBI electric 4 gallon backpack sprayer equipped with 11004 nozzles with a spray pressure of 35 psi calibrated to deliver about 40 gallons per acre spray volume, respectively. All applications were applied on the same day. The wind speed was less than 10 mph at time of application.

Pyridate used in this trial was a five pound active ingredient per gallon emulsifiable concentrate (EC) marketed by Belchim Crop Protection as Tough® 5EC Herbicide. The sulfentrazone used in this trial was Sulfentrazone 4L Select marketed by Prime Source, a division of Albaugh, LLC. The treatments included: (1) Pyridate applied alone at a rate of 24 fluid ounces per acre; (2) Sulfentrazone alone applied at a rate of 12 fluid ounces per acre; and (3) a combination of Pyridate applied at 24 fluid ounces per acre and Sulfentrazone applied at a rate of 12 fluid ounces per acre. All treatments were compared visually to an untreated control plot.

Data were collected at 10 days after application of treatments respectively as an estimate of overall percent weed control (efficacy) of combined weed species taking into consideration necrosis, chlorosis, and stunting of each weed species. At 10 days after treatment (DAT), Pyridate applied at a rate of about 24 fluid ounces per acre provided only slight weed efficacy on yellow nutsedge at approximately 20% control. Sulfentrazone applied alone at 12 fluid ounces per acre provided efficacy of yellow nutsedge at approximately 70% control. The combination of pyridate (24 fluid ounces per acre) and sulfentrazone (12 fluid ounces per acre) provided 100% control of yellow nutsedge and provided statistically significantly better control when compared to either of these products alone (see Table 1).

TABLE 1

| | | Percentage |
|---|---|---|
| | | (%) Control |
| | | 10 Days after |
| Treatment | Treatment and Treatment | Treatment |
| No. | Rate (fluid ounces/acre) | (DAT) |
| 1 | Untreated Control | 0 |
| 2 | Pyridate Alone (24 oz/acre) | 20 |
| 3 | Sulfentrazone Alone (12 oz/acre) | 70 |
| 4 | Pyridate (24 oz/acre) + | 100 |
| | Sulfentrazone (12 oz/acre) | |

These data suggest a synergistic effect when combining pyridate and sulfentrazone.

### Example 2

A study was conducted to evaluate and compare the post-emergent control of green Kyllinga (Kyllinga brevifolia) versus the industry standards of Sulfentrazone Select or Halosulfuron 75 WDG. The study was conducted at a tall fescue site at the Virginia Tech Golf Course in Blacksburg, VA. A randomized block design with four replications was utilized. Treatments were applied with a CO₂ pressurized spray system. Irrigations were suspended for at least 24 hours after application. The study design is set forth in Table 2.

TABLE 2

| | | Formulation | |
|---|---|---|---|
| Treatment | | Concentration/ | Application |
| No. | Treatment | Unit/Type | Rate |
| 1 | Untreated Control | Untreated | Untreated |
| | | Control | Control |
| 2 | Sulfentrazone Select | 4 lb/gallon SC | 8 fl oz/acre |
| | NIS (adjuvant) | 100% SC | 0.25% v/v |
| 3 | Halosulfuron 75 WDG | 75% WDG | 1.33 oz/acre |
| | NIS (adjuvant) | 100% SC | 0.25% v/v |
| 4 | Pyridate + Sulfentrazone | 2.423 lb/gallon SC | 32 fl oz/acre |
| | NIS (adjuvant) | 100% SC | 0.25% v/v |
| 5 | Pyridate + Sulfentrazone | 2.423 lb/gallon SC | 32 fl oz/acre |
| | BSK-101 (adjuvant) | 10% L | 0.25% v/v |

### Results

The application of Sulfentrazone Select, Pyridate+Sulfentrazone as well as Pyridate+Sulfentrazone in combination with BSK-101 caused 15% injury to tall fescue at 14 days after treatment, however, the injuries decreased over time.

At 14 days after treatment, green Kyllinga control was greater than 95% for Sulfentrazone Select, Pyridate+Sulfentrazone as well as Pyridate+Sulfentrazone in combination with BSK-101. The Halosulfuron 75 WDG applicant resulted in less than 70% Kyllinga control.

At 28 days after treatment, green Kyllinga control was greater than 95% for all treatments.

At 91 days after treatment, green Kyllinga control was still greater than 95% for all treatments.

In summary, the data suggest that the combination of Pyridate and Sulfentrazone (treatments 4 and 5) exhibit statistically significant improved green Kyllinga compared to the sole application of Sulfentrazone Select or Halosulfuron 75 WDG, alone, after 14 days and comparable Kyllinga control at 28 and 91 days after control.

### Example 3

A study was conducted to evaluate and compare the post-emergent control of green Kyllinga (Kyllinga brevifolia) versus the industry standards of Sulfentrazone Select or Halosulfuron 75 WDG. The study was conducted in Hampstead, North Carolina at Old Pointe Country Club. A randomized block design with four replications was utilized. Treatments were applied with a CO₂ pressurized spray system. Irrigations were suspended for at least 24 hours after application. The study design is set forth in Table 3 and results are shown in Table 4.

TABLE 3

| Treatment | | |
|---|---|---|
| No. | Treatment | Application Rate |
| 1 | Untreated Control | Untreated Control |
| 2 | Sulfentrazone Select | 0.184 fl oz/1000 ft² |
| 3 | Halosulfuron 75 WDG | 0.0305 oz wt/1000 ft² |
| 4 | Pyridate + Sulfentrazone | 0.735 fl oz/1000 ft² |
| 5 | Pyridate + Sulfentrazone | 0.735 fl oz/1000 ft² |
| | BSK-101 (adjuvant) | 0.735 fl oz/1000 ft² |

TABLE 4

| Treatment | | | | | | |
|---|---|---|---|---|---|---|
| No. | Treatment | Percentage Control | | | | |
| 1 | Untreated | 7 | 14 | 21 | 28 | 35 |
| | Control | DAT | DAT | DAT | DAT | DAT |
| 2 | Sulfentrazone | 86.8 | 80.0 | 63.3 | 53.3 | 43.3 |
| | Select | | | | | |
| 3 | Halosulfuron 75 | 36.6 | 63.3 | 81.7 | 75.0 | 71.7 |
| | WDG | | | | | |
| 4 | Pyridate + | 83.6 | 90.0 | 81.7 | 76.7 | 73.3 |
| | Sulfentrazone | | | | | |
| 5 | Pyridate + | 90.0 | 88.3 | 71.7 | 65.0 | 56.7 |
| | Sulfentrazone | | | | | |
| | BSK-101 | | | | | |
| | (adjuvant) | | | | | |

### Results

The results suggest that the combination of Pryidate and Sulfentrazone provided an improved kill of Green Kyllinga. It not only increased speed of control but it also increased the length of control. At 35 DAT (Days after treatments) Sulfentrazone alone provided 43.3% control where the combination of Pyridate and Sulfentrazone provided 73.3% control.

### Example 4

A study was conducted to evaluate and compare the post-emergent control of Yellow Nutsedge versus the industry standards of Sulfentrazone Select or Halosulfuron 75 WDG. The study was conducted in Hampstead, North Carolina at Old Pointe Country Club. A randomized block design with four replications was utilized. Treatments were applied with a CO₂ pressurized spray system. Irrigations were suspended for at least 24 hours after application. The study design is set forth in Table 5 and results are shown in Table 6.

TABLE 5

| Treatment | | |
|---|---|---|
| No. | Treatment | Application Rate |
| 1 | Untreated Control | Untreated Control |
| 2 | Sulfentrazone Select | 0.184 fl oz/1000 ft² |
| 3 | Halosulfuron 75 WDG | 0.0305 oz wt/1000 ft² |
| 4 | Pyridate + Sulfentrazone | 0.735 fl oz/1000 ft² |
| 5 | Pyridate + Sulfentrazone | 0.735 fl oz/1000 ft² |
| | BSK-101 (adjuvant) | 0.735 fl oz/1000 ft² |

TABLE 6

| Treatment | | | | | | |
|---|---|---|---|---|---|---|
| No. | Treatment | Percentage Control | | | | |
| 1 | Untreated | 7 | 14 | 21 | 28 | 35 |
| | Control | DAT | DAT | DAT | DAT | DAT |
| 2 | Sulfentrazone | 68.5 | 73.3 | 71.7 | 66.7 | 60.0 |
| | Select | | | | | |
| 3 | Halosulfuron 75 | 72.0 | 78.3 | 73.3 | 71.7 | 63.3 |
| | WDG | | | | | |
| 4 | Pyridate + | 91.8 | 93.3 | 90.0 | 88.3 | 80.0 |
| | Sulfentrazone | | | | | |
| 5 | Pyridate + | 85.6 | 81.7 | 78.3 | 76.7 | 73.3 |
| | Sulfentrazone | | | | | |
| | BSK-101 | | | | | |
| | (adjuvant) | | | | | |

### Results

The results suggest that the combination of Pyridate and Sulfentrazone provided an improved kill of Yellow Nutsedge. It not only increased speed of control but it also increased the length of control. At 35 DAT (Days after treatments) Sulfentrazone alone provided 60% control where the combination of Pyridate and Sulfentrazone provided 80% control. This combination will also be advantageous to overcome resistance since it features multiple modes of actions that act different on the unwanted plants.

1. An herbicidal composition comprising:
at least one photosynthesis II inhibitor; and
at least one protoporphyrinogen oxidase (PPO).

2. The herbicidal composition of claim 1, wherein the at least one photosynthesis II inhibitor is a symmetrical triazine, triazinone, triazole, triazolone, triazolinone, substituted urea, uracil, pyridazinone, phenyl carbamate, nitrile, benzothiadiazole, phenyl pyridazine, phenyl-carbamate, or acid amide.

3. The herbicidal composition of claim 1, wherein the at least one photosynthesis II inhibitor is pyridate, amicarbazone, bromacila, chloridazone/pyrazone, demedipham, lenacil, pentanochlor, fenmedipham, propanyl, pyridafol, terbacyl, tidiazurone, or agriculturally acceptable salts thereof.

3. The herbicidal composition of claim 1, wherein the at least one photosynthesis II inhibitor is pyridate.

4. The herbicidal composition of claim 1, wherein the at least one protoporphyrinogen oxidase (PPO) is sulfentrazone, piralflufen-ethyl, carfentrazone-ethyl, flumioxazin, butafenacil, saflufenacil, oxadiargyl, pentoxazone, flutiacet-methyl, piraclonyl o-flurfenpyr-ethyl or agriculturally acceptable salts thereof.

5. The herbicidal composition of claim 1, wherein the at least one protoporphyrinogen oxidase (PPO) is sulfentrazone.

6. The herbicidal composition of claim 1, formulated as a ready-to-use (RTU) formulation, emulsifiable concentrate (EC), microemulsifiable concentrate, oil dispersion (OD), powder, water dispersible granule (WG), or water soluble granule (SG).

7. A method for burndown treatment of undesirable vegetation comprising:
applying the herbicidal composition of claim 1 onto or around:
i) a locus where desirable will be planted or emerge; or
ii) a locus where undesirable vegetation is present or is expected to be present.

8. The method of claim 7, wherein the undesirable vegetation is a sedge.

9. A method of controlling growth of undesirable vegetation comprising:
applying the herbicidal composition of claim 1 onto or around:
i) a locus where desirable vegetation will be planted or emerge; or
ii) a locus where undesirable vegetation is present or is expected to be present.

10. The method of claim 9, wherein the undesirable vegetation is a sedge.

11. A kit comprising:
at least one herbicidal composition of claim 1; and
optionally, instructions for use.

12. A tank mix herbicidal composition comprising:
at least one herbicidal composition of claim 1; and
water, spray oil, or a combination of water and spray oil.

13. A herbicidal composition comprising:
about 0.01 percent weight to about 0.5 percent weight of at least one photosynthesis II inhibitor; and
about 0.01 weight percent to about 0.5 weight percent of at least one at least one protoporphyrinogen oxidase (PPO).

14. The herbicidal composition of claim 13, wherein the at least one photosynthesis II inhibitor is pyridate.

15. The herbicidal composition of claim 13, wherein the at least one protoporphyrinogen oxidase (PPO) is sulfentrazone.

16. The herbicidal composition of claim 13, formulated as a ready-to-use (RTU) formulation, emulsifiable concentrate (EC), microemulsifiable concentrate, oil dispersion (OD), powder, water dispersible granule (WG), or water soluble granule (SG).

17. The herbicidal composition of claim 13, formulated as a ready-to-use (RTU) formulation comprising:
from about 0.0175% v/v to about 0.5% v/v of at least one photosynthesis II inhibitor per gallon of RTU formulation; and
from about 0.0162% v/v to about 0.6% v/v of at least one protoporphyrinogen oxidase (PPO) inhibitor per gallon of RTU formulation.
